(19) United States
(12) Patent Application Publication
(10) Pub. No.: US 2019/0239038 A1
(43) Pub. Date: Aug. 1, 2019

(54) DATING APPLICATION

(71) Applicant: Anupama Padiadpu Subramanya Bhat, Costa Mesa, CA (US)

(72) Inventor: Anupama Padiadpu Subramanya Bhat, Costa Mesa, CA (US)

(21) Appl. No.: 16/262,008

(22) Filed: Jan. 30, 2019

Related U.S. Application Data
(60) Provisional application No. 62/624,819, filed on Feb. 1, 2018.

(51) Int. Cl. H04W 4/21; G06Q 10/06; H04L 29/06; H04W 4/029; H04L 29/08; H04L 12/58

(52) U.S. Cl. CPC H04W 4/21; G06Q 10/067; H04L 51/10; H04W 4/029; H04L 67/306; H04L 63/10

(57) ABSTRACT

This disclosure also relates to a Dating app for mutual private videos matching for bulk messages/media shared and also for Live tracking and discovering single people within a short range of about 1 mile radius. This disclosure additionally relates to a Dating app for mutual private videos matching for bulk messages/media shared and also for Live Events/date venue ideas based on live video snippet/media.

### CROSS-REFERENCE TO RELATED APPLICATIONS

This application claims priority to Provisional Patent Application Ser. No. 62/624,819, filed on Feb. 1, 2018, the entire content of which is expressly incorporated herein by reference. Moreover, the entire content of Provisional Patent Application Ser. No. 62/655,228, filed on Apr. 10, 2018 is also expressly incorporated herein by reference.

### STATEMENT RE: FEDERALLY SPONSORED RESEARCH/DEVELOPMENT

Not Applicable

### BACKGROUND

The present invention relates to mutual private videos matching with media content for real connections (avoid catfish). Another embodiment is groups of suitors/friends for bulk messages/media shared. Another embodiment of the present invention is Live tracking for discovering single people within a short range of about 1 mile radius. Additional embodiment is Dating ideas based on Facebook/Evenbrite events through API. Moreover, the present invention relates to mutual private videos with media content for real connections (avoid catfish) watched after profiles matching. Another embodiment is groups of suitors/friends for bulk messages/media shared. Another embodiment of the present invention is Live discovering of single people with the purpose of immediate live social interaction to talk/date/be approached within a short range of GPS radius based on user permission for discovering. Additional embodiment is dating ideas based on live events or social events like that from Facebook/Eventbrite events through API or created by user.

A matching service attempts to identify and bring together two or more people that the matching service believes may have a successful relationship. Many matching services identify matches by techniques that find people with common personalities, interests and/or beliefs. However, these matching techniques often do not account for the large number of variables that can determine whether a relationship is successful. Research has shown that the success of human relationships depends on complex interactions between a large number of variables including, but not limited to, personality, socioeconomic status, religion, appearance, ethnic background, energy level, education, interests and appearance. The large number of variables involved in determining relationship success has made predicting the success of a relationship to be very unreliable.

After identifying candidates for a match, many matching services allow the candidates to communicate by telephone or by e-mail. Many people are not comfortable communicating with a new person in such an immediately open format. As a result, many people would be comfortable with a more gradual and less personal introduction to new people. Accordingly, there is a need for providing communication between matched candidates that is comfortable to the candidates.

Previously, various constructions have been provided however, to Applicant's knowledge, none of these prior art methods have been found to be completely suitable to meet these needs and are cumbersome. The present invention provides such an application and the overall combination of these features is nowhere disclosed in the prior art cited above which appears to be representative of the general art in this area although it is not intended to be an all-inclusive listing of pertinent prior art patents.

In a different aspect, a matching service attempts to identify and bring together two or more people that the matching service believes may have a successful relationship. Many matching services identify matches by techniques that find people with common personalities, interests and/or beliefs. However, these matching techniques often do not account for the large number of variables that can determine whether a relationship is successful. Research has shown that the success of human relationships depends on complex interactions between a large number of variables including, but not limited to, personality, socioeconomic status, religion, appearance, ethnic background, energy level, education, interests and appearance. The large number of variables involved in determining relationship success has made predicting the success of a relationship to be very unreliable.

There have been many prior art improvements to online dating systems. One prior art taught in U.S. Pat. No. 7,246,067 issued to Austin on Jul. 17, 2007 describes a method for verifying information submitted by users to an online dating system. Another prior art taught in U.S. Pat. No. 7,203,674 issued to Cohen on Apr. 10, 2007 describes a method and system for integrating real-time speed dating with an electronic dating service. Yet another prior art taught in U.S. Pat. Application No. 20060059130 published to Weiss on Mar. 16, 2006 describes a system and method for improving an online dating service's search results based on a user's compatibility feedback. However, all of the prior patents suffer from shortcomings the present invention provides such an application and the overall combination of these features is nowhere disclosed in the prior art cited above which appears to be representative of the general art in this area although it is not intended to be an all-inclusive listing of pertinent prior art patents.

### BRIEF SUMMARY

According to a first embodiment the present invention is to show private videos to users only after mutual like and understanding. The video is private and shown only to the two parties who like each other. This video saves dating fatigue by repeatedly communicating past life details about themselves to potential suitors. By the video being private and shared with mutual likes it reduces the time spent on communication and reduces Dating Fatigue, helps having more effective meaningful conversations. Dating fatigue is caused by repeatedly texting/talking with many suitors about basic personal details like and not limited to details of past education, places lived/travelled, religious/spiritual beliefs, personality type, hobbies/passions, life journey details. By having videos in private to share this it will greatly reduce the burden on the user to talk about these details and focus more on building a relationship understanding the past details better.

Embodiments of the invention relates to private list of suitors to share daily bulk messages/media. This probate list is the top certain number of favorite or potential suitors from the many matches on the app. This communication could be sending media, videos/audio or text for meeting for events for date or outdoor/indoor activities or basic requests to meet during gym, grocery shopping etc.

Another embodiment of the present invention is audio text/clip used for communication for dating purpose. It is basically streaming voice for mobile communication between users for dating purpose. Psychological research studies prove audio communication helps attain better connection for matching compared to texting.

Another embodiment of the present invention relates to Date ideas for Events from Eventbrite, Facebook, using API. Social events which can help you determine potential suitor's responses to different situations in real life.

Another exemplary embodiment of the present invention relates to sharing single status (without name mentioned just with basic profile information like age, education, job etc) of user in a mile radius so as to be discovered/encountered by other potential single users at a Bar/wedding/activity venues based on short line of sight GPS location radius.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

According to a second embodiment the present invention is to show private videos to users only after user likes a profile and the liked profile users also likes back the user. The video is private and shown only to the two parties who like each other's profiles. This video saves dating fatigue by repeatedly communicating past life details about themselves to potential suitors. By the video being private and shared with mutual likes it reduces the time spent on communication and reduces Dating Fatigue, helps having more effective meaningful conversations by looking at personality of a person. Dating fatigue is caused by repeatedly texting/talking with many suitors about basic personal details like and not limited to details of past education, places lived/travelled, religious/spiritual beliefs, personality type, hobbies/passions, life journey details. By having videos in private to share this it will greatly reduce the burden on the user to talk about these details and focus more on building a relationship understanding the past details better.

Embodiments of the invention relates to limited private list of suitors to share daily bulk messages/media. This probate list is the top certain number of favorite or potential suitors from the many matches on the app. This communication could be sending media, videos/audio or text for meeting for events for date or outdoor/indoor activities or basic requests to meet during gym, grocery shopping etc. The receiver does not know that this was a bulk message/media sent, as well as who are the other users who received this information.

Another embodiment of the present invention relates to Events as date ideas from Eventbrite, Facebook, using API or live events which shows media of the event live. Social events/gatherings which can help you determine potential suitor's responses to different situations in real life. It could also have other social events for causes, job fairs, workshops to help students, professionals.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

These and other features and advantages of the various embodiments disclosed herein will be better understood with respect to the following description and drawings, in which like numbers refer to like parts throughout, and in which:

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 100 shows private videos shown to users only after mutual like.

FIG. 200 shows Private list of friends/contacts for bulk messages.

FIG. 300 shows Private list of suitors to share daily bulk messages/media.

FIG. 400 shows Audio text/clip used for communication or Dating purpose.

FIG. 500 shows private videos shown to users only after mutual like.

FIG. 600 shows Private list of friends/contacts for bulk messages.

FIG. 700 shows Private list of suitors to share daily bulk messages/media.

FIG. 800 shows Live Event option.

FIG. 900 shows another view of live and social events.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Before explaining the invention in detail, it is to be understood that the invention is not limited in its application to the detail of application illustrated in the drawings since the invention is capable of other embodiments and of being practiced or carried out in various ways. It is also to be understood that the phraseology or terminology employed is for the purpose of description only and not of limitation.

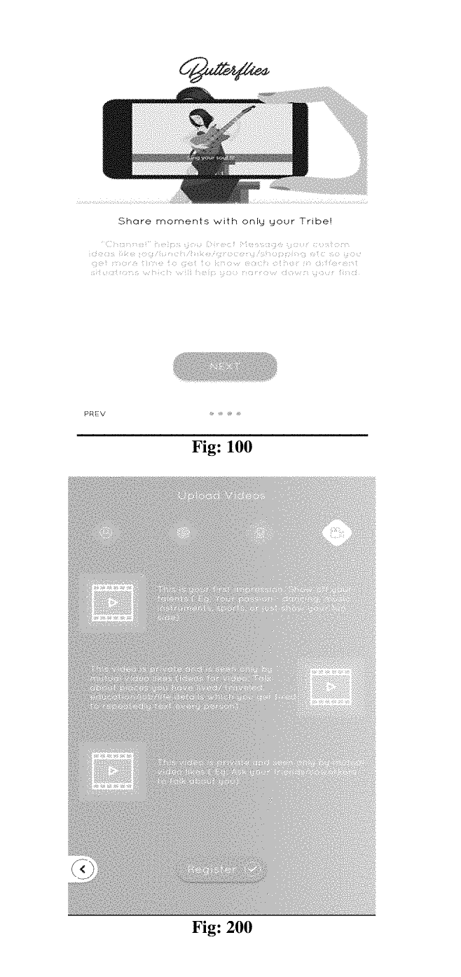

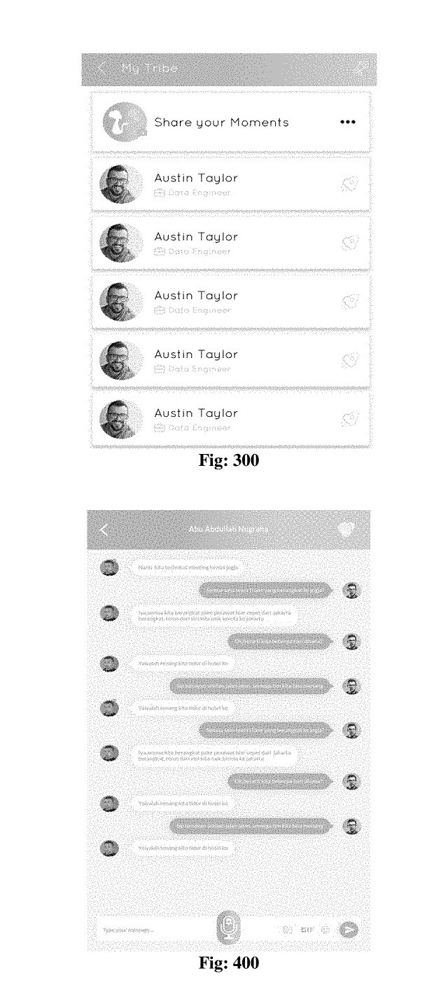

Referring now to FIGS. 100-400, before explaining the invention in detail, it is to be understood that the invention is not limited in its application to the detail of application illustrated in the drawings since the invention is capable of other embodiments and of being practiced or carried out in various ways. It is also to be understood that the phraseology or terminology employed is for the purpose of description only and not of limitation.

The present invention is a dating app with Private videos shown to users only after mutual like. The video is private and shown only to the two parties who like each other. This video helps save dating fatigue by repeatedly communicating details about themselves to potential suitors. The video being private and shared with mutual likes it reduces the time spent on communication and reduces dating Fatigue, helps having more effective meaningful conversations. Dating fatigue is caused by repeatedly texting/talking with many suitors about basic personal details like and not limited to details of past education, places lived/travelled, religious/spiritual beliefs, personality type, hobbies/passions, life journey details. By having videos in private to share this it will greatly reduce the burden on the user to talk about these details and focus more on building a relationship understanding the past details better.

Another embodiment of the present invention is Private list of suitors to share daily bulk messages/media. This probate list is the top certain number of favorite or potential suitors from the many matches on the app. This communication could be sending media, videos/audio or text for meeting for events for date or outdoor/indoor activities or basic requests to meet during gym, grocery shopping etc. Audio text/clip used for communication for dating purpose. It is basically streaming voice for mobile communication between users for dating purpose

The dating application meets important existing needs and removes both technical and psychological obstacles. The very existence of the dating application makes matchmaking a socially legitimate activity. A further advantage of the present invention is to Share single status (without name mentioned just with basic profile information like age, education, job etc.) of user in a mile radius so as to be discovered/encountered by other potential single users at a Bar/wedding/activity venues based on GPS location.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

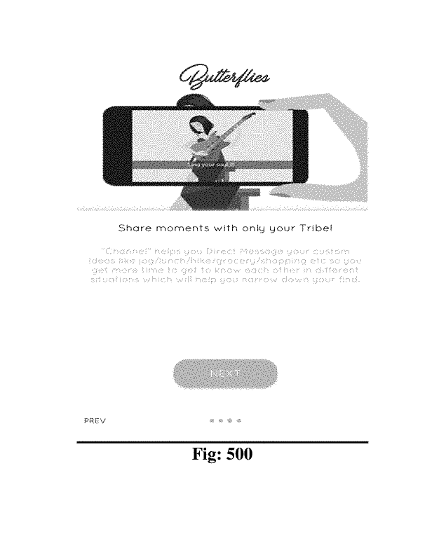

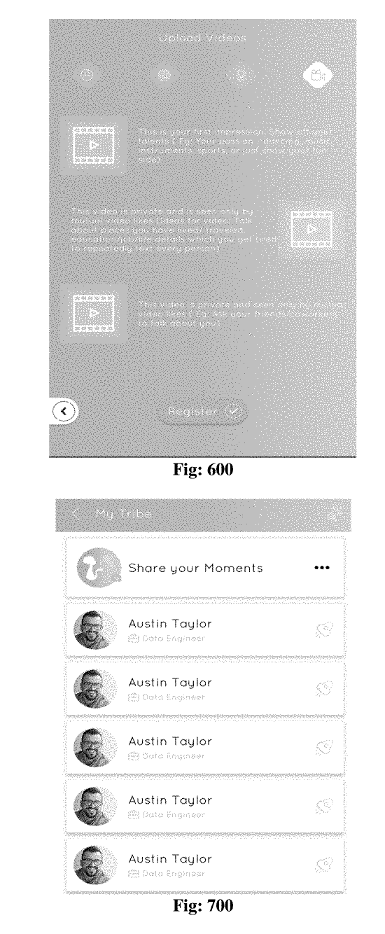

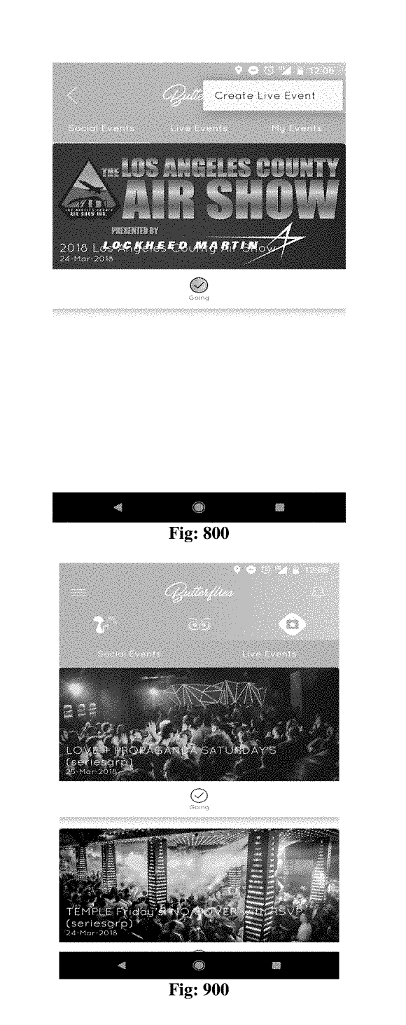

Referring now to FIGS. 500-900, before explaining the invention in detail, it is to be understood that the invention is not limited in its application to the detail of application illustrated in the drawings since the invention is capable of other embodiments and of being practiced or carried out in various ways. It is also to be understood that the phraseology or terminology employed is for the purpose of description only and not of limitation.

The present invention is a dating app with Private videos shown to users only after mutual like. The video is private and shown only to the two parties who like each other. This video helps save dating fatigue by repeatedly communicating details about themselves to potential suitors. The video/audio being private and shared with mutual profile likes, reduces the time spent on communication and reduces dating Fatigue, helps having more effective meaningful conversations. Dating fatigue is caused by repeatedly texting/talking with many suitors about basic personal details like and not limited to details of past education, places lived/travelled, religious/spiritual beliefs, personality type, hobbies/passions, life journey details. By having videos in private to share this it will greatly reduce the burden on the user to talk about these details and focus more on building a relationship understanding the past details better.

Another embodiment of the present invention is Private list of suitors to share daily bulk messages/media. This probate list is the top certain number of favorite or potential suitors from the many matches on the app. This communication could be sending media, videos/audio or text for meeting for events for date or outdoor/indoor activities or basic requests to meet during gym, grocery shopping etc.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

What is claimed is:

1. A dating app comprising:
mutual based private videos matching.
private list of suitors (potential dating people) for bulk messages/media shared.
audio clips/texts used for Dating app chatting/communication.
events API used for Dating purpose.
Live video share of events/parties/clubs/restaurant/dance places etc. for dating purpose (Single people audience).
Live tracking of discovering single people within a short Line of sight or 1 mile GPS location radius.

2. A dating app comprising:
mutual based private videos matching after mutual profile/video like, the video/audio is private and shown only to the two parties who like each other.
private list of suitors (potential dating people) for bulk messages/media shared, the communication could be sending media, videos/audio or text for meeting for events for dating or outdoor/indoor activities or basic requests to meet during gym, grocery shopping etc.
Private list of friends/contacts for bulk messages. It could be for asking recommendations/tips/suggestions or for daily activities like catching up for dinner/movie/shopping/game.
Date ideas for events based on Events which are Live media or API such as from Eventbrite, Facebook or Live events created by user. Social events which can help to determine potential suitors responses to different situations in real life. The user RSVP could also be updated on Facebook.
Live video share of venues/events/parties/clubs/restaurant/dance places etc. for dating purpose (Single people audience). Users create these events and share live video/audio/media broadcast of the venue to attract users. It could also be around a short-fixed GPS perimeter close to the venue.
Business Revenue model created for dating purpose-based video snippets from Venues like from event spaces, museums, art galleries, bars, clubs, shows, fitness centers, restaurants, any activity centers.
Live user profile discovery based on user consent/request. User age and height is only shown with picture around a short radius of GPS at events only if the user wants to be approached in person to talk/date based on consent. This is exclusively to indicate that the user who has the profile set for live discovery is interested in social interaction, relieving a user who wants to approach someone who he/she is interested in but unsure if they are open to be approached in person at restaurants/grocery/walking/clubs/bars/weddings/events, anywhere in public/private spaces. The user is contacted/requested for profile details by the interested person on the App who discovers the user on the app or from line of sight. This way the user see who the person possibly is in real before accepting request to show the entire profile details. When the user approves, the profile details are shown to the requesting user, while also showing the profile details of the requesting user. The dating profile details could entail the profession, education, food preferences, personality type, hobbies/interests, biography, additional pictures, videos on profile also contact information if user approves. This opens up more preferred prospects of communication for singles based on their individual preferences. This is like a virtual contact card info exchange.
